(19) United States
(12) Patent Application Publication
(10) Pub. No.: US 2013/0179670 A1
(43) Pub. Date: Jul. 11, 2013

(54) BOOTING METHOD OF MULTIMEDIA DEVICE AND MULTIMEDIA DEVICE

(71) Applicants: Hong-Ming Liu, Shanghai (CN); Xiang Long, Shanghai (CN); Kun-Ming Yi, Zhejiang (CN); Shao-Fang Pei, Shanghai (CN)

(72) Inventors: Hong-Ming Liu, Shanghai (CN); Xiang Long, Shanghai (CN); Kun-Ming Yi, Zhejiang (CN); Shao-Fang Pei, Shanghai (CN)

(73) Assignee: NOVATEK MICROELECTRONICS CORP., Hsinchu (TW)

(21) Appl. No.: 13/437,880

(22) Filed: Apr. 2, 2012

(30) Foreign Application Priority Data
Jan. 9, 2012 (CN) 201210004294.6

(51) Int. Cl. G06F 9/24

(52) U.S. Cl. 713/2

(57) ABSTRACT

A booting method of a multimedia device and the multimedia device are provided. The multimedia device includes a storage media, and the booting method of the multimedia device includes following steps. After the multimedia device is powered on, a boot loader is executed to initialize a plurality of primary components of the multimedia device. A snapshot information is read from the storage media, wherein the snapshot information includes a plurality of state information of an operating system (OS) and a plurality of applications of the multimedia device. The snapshot information is loaded into the multimedia device to allow the multimedia device to run the OS and the applications. Thereby, the number of booting steps of the multimedia device is reduced, and the booting time of the multimedia device is effectively shortened.

### CROSS-REFERENCE TO RELATED APPLICATION

This application claims the priority benefit of China application serial no. 201210004294.6, filed on Jan. 9, 2012. The entirety of the above-mentioned patent application is hereby incorporated by reference herein and made a part of this specification.

### BACKGROUND OF THE INVENTION

1. Field of the Invention

The invention generally relates to a fast booting technique, and more particularly, to a booting method of a multimedia device and the multimedia device thereof.

2. Description of Related Art

Old-fashioned multimedia devices (for example, TVs, cell phones, and music players, etc.) perform very limited functions therefore can be booted up quickly. However, due to the limitation in the function performed by each multimedia device, a user has to use many different multimedia devices to achieve different functions. Along with the development of technologies, multimedia devices have been designed to provide diverse functions so that a user needs not to purchase many different multimedia devices and can enjoy the many different functions provided by a single multimedia device. However, such a design prolongs the booting procedure of a multimedia device.

Taking today's television devices (for example, smart TVs and Internet TVs) as an example, because many application software are ran and the application software have to be initialized one by one during the booting procedure, the booting procedure is slowed down. Some television devices (for example, smart TVs with the Android operating system) may even need tens of seconds to be completely booted up.

The booting procedure of a multimedia device can be described by referring to FIG. 1. FIG. 1 is a flowchart of a regular booting procedure of a multimedia device. Referring to FIG. 1, in step S110, a user powers on the multimedia device by pressing down the switch of the multimedia device or by using a remote control. In step S120, the multimedia device executes a boot loader (for example, related program codes of the Basic Input/Output System (BIOS)). The boot loader initializes main hardware and related components (for example, a central processing unit (CPU), a non-volatile storage media, and a volatile computer memory) in the multimedia device, tests functions of aforementioned hardware, and loads an operating system (OS). For example, the boot loader sequentially configures the operating speed of a CPU and the access speed of a memory and tests the accessibility of a hard disc at this moment.

Then, in step S130, the multimedia device reads the kernel code of the OS from the non-volatile storage media (for example, a flash memory or a hard disc) to the volatile computer memory (for example, a dynamic random access memory (DRAM)) and executes the kernel of the OS through a central processor. In the present embodiment, the OS may be the open-source Linux OS or Android OS or the closed-source Windows OS or ios OS. However, the OS mentioned in the invention is not limited to foregoing examples, and those implementing the present embodiment should be able to apply the present embodiment to different OS.

After the kernel of the OS is started, in step S140, the multimedia device establishes a shell or a console defined by the OS or the user. In other words, in step S140, the multimedia device establishes a graphic interface or a command line (for example, the windows interface of the Windows OS and X-window of the Linux OS) to be operated by the user.

After the OS and the shell thereof are established (as in step S140), in step S150, the multimedia device initializes applications one by one. Herein the applications may be services provided by the multimedia device and related processes and threads. Or, the applications may also be software databases to be used in subsequent applications and drivers of specific hardware in the multimedia device (for example, drivers of an audio decoder and a video decoder). After all the applications are initialized, in step S160, the user controls the multimedia device to perform corresponding operations through an input interface (for example, a remote control or a keyboard). Herein a television device will be taken as an example of the multimedia device. The user can only switch TV channels, adjust speaker volume, and play TV programs after steps S110-S150 are completed. Namely, the user cannot operate the multimedia device when the steps S110-S150 are being executed. Thereby, how to speed up the booting procedure of a multimedia device has become one of today's subjects in the industry.

### SUMMARY OF THE INVENTION

Accordingly, the invention is directed to a booting method of a multimedia device and the multimedia device, in which when the multimedia device is booted, a snapshot information obtained by taking a snapshot when an operating system (OS) and a plurality of applications are in a good state is loaded so that the number of booting steps of the multimedia device is reduced and the booting time of the multimedia device is effectively shortened.

The invention provides a booting method of a multimedia device. The multimedia device includes a storage media. The booting method includes following steps. When the multimedia device is powered on, a boot loader is executed to initialize a plurality of primary components of the multimedia device. A snapshot information is read from the storage media, wherein the snapshot information includes a plurality of state information of an OS and a plurality of applications of the multimedia device. The snapshot information is loaded into the multimedia device to allow the multimedia device to instantly run the OS and the applications.

According to an embodiment of the invention, the multimedia device further includes a volatile memory, and the booting method further includes following steps. When the OS and the applications are in a good state, data in the volatile memory is saved to take a snapshot and generate the snapshot information.

According to an embodiment of the invention, the booting method further includes following steps. When the OS and the applications are in the good state, a plurality of storage pages in the currently used volatile memory is saved to respectively take snapshots on a plurality of states of the OS and the applications and respectively generate the state information in the snapshot information.

According to an embodiment of the invention, the step of loading the snapshot information into the multimedia device further includes following steps. The state information while the OS and the applications are in the good state is written into the volatile memory according to the snapshot information.

According to an embodiment of the invention, after the step of reading the snapshot information, the booting method further includes following steps. A plurality of secondary components are initialized, wherein the secondary components are corresponding to the snapshot information.

The invention provides a multimedia device including a central processing unit, a storage media, and a volatile memory. The storage media is coupled to the central processing unit and configured to store a snapshot information, wherein the snapshot information includes a plurality of state information of an OS and a plurality of applications of the multimedia device. The volatile memory is coupled to the central processing unit and the storage media. After the multimedia device is powered on, the central processing unit executes a boot loader to initialize a plurality of primary components of the multimedia device, reads the snapshot information from the storage media, and loads the snapshot information into the volatile memory to instantly run the OS and the applications.

Other implementation details of the multimedia device can be referred to descriptions of foregoing multimedia device and will not be described herein.

As described above, in a multimedia device and a booting method thereof provided by an embodiment of the invention, a snapshot is taken in advance on an OS and a plurality of applications when the multimedia device is in a good state, so as to generate current snapshot information. Then, during the booting procedure of the multimedia device, the snapshot information is loaded so that the OS and the applications need not to be configured through a conventional booting procedure. Thereby, the number of booting steps of the multimedia device is reduced, and booting time of the multimedia device is effectively shortened.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart of a regular booting procedure of a multimedia device.

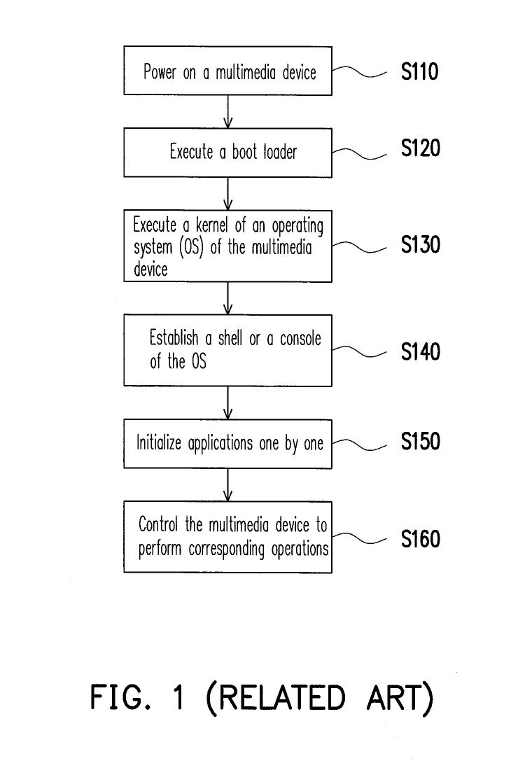

FIG. 2 is a function block diagram of a multimedia device according to a first embodiment of the invention.

FIG. 3 is a flowchart of a booting method of a multimedia device according to the first embodiment of the invention.

FIG. 4 is a function block diagram of a multimedia device according to a second embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Along with the increase in the program codes and number of the applications, the multimedia device takes a lot of time to initialize the OS and the applications, which directly results in a prolonged booting procedure. In order to resolve this problem, every existing technique developed to speed up the booting procedure tries to shorten the time for initializing the OS or the applications or omit some steps in the initialization process of the OS. However, the time for initializing the OS and the applications cannot be shortened unlimitedly. Besides, a current problem is that in order to allow a user to adjust functions provided by a multimedia device, every existing OS allows the user to install new applications according to the user's requirement. Thus, the number of applications to be initialized during the booting procedure will increase continuously, and as a result, the time for initializing the applications will extends continuously.

In the present embodiment, a snapshot is taken in advance regarding the state of the OS shell and the applications at a time point when the booting procedure of the multimedia device is completed and the OS and the applications all work normally (i.e., the OS and the applications are all in a good state at this time point), and the current state of the OS and the applications is saved to generate a snapshot information.

“Snapshot” is a photographic term used herein to indicate an action which is like taking picture for all people in the same image, wherein each person has his/her own state transformation. However, in the present embodiment, everybody is made to smile (the state information of each software in the good state) and a picture is taken on all people to store their smile in the picture.

Thereby, when a multimedia device executes the booting method described in the present embodiment, aforementioned snapshot information is loaded into the multimedia device to allow the OS and the applications in the good state to be instantly and directly ran in the multimedia device. Thus, the conventional booting procedure in which the OS and the applications are initialized one by one is not needed in the present embodiment. Accordingly, the number of booting steps of the multimedia device is reduced, and the booting time of the multimedia device is effectively shortened. In short, the booting efficiency of the multimedia device is improved. Below, an application of the embodiment will be described.

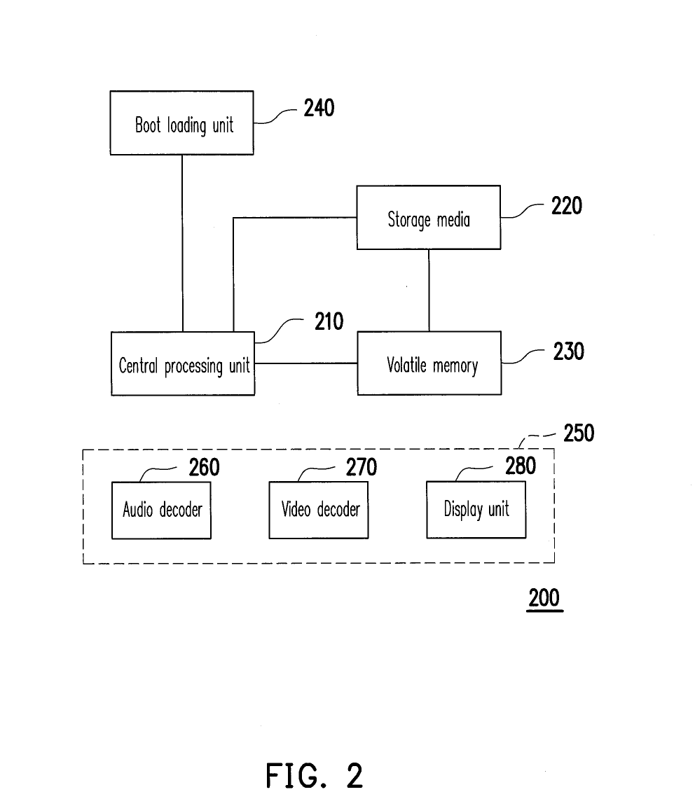

FIG. 2 is a function block diagram of a multimedia device 200 according to a first embodiment of the invention. Referring to FIG. 2, the multimedia device 200 includes a central processing unit 210, a storage media 220, and a volatile memory 230. The central processing unit 210 is coupled to the storage media 220 and the volatile memory 230. The storage media 220 is coupled to the volatile memory 230 through a direct memory access (DMA) technique. In the present embodiment, the central processing unit 210, the storage media 220, and the volatile memory 230 are all referred to as primary components of the multimedia device 200. In the present embodiment, the storage media 220 is a non-volatile memory, such as a hard disc or a flash memory, and the volatile memory 230 is a double data rate (DDR) random access memory (RAM) used by a computer or any related device.

In the present embodiment, the multimedia device 200 further includes a boot loading unit 240 and secondary components 250. The boot loading unit 240 is coupled to the central processing unit 210 via a transmission path (for example, a south bridge chip or chipset). The boot loading unit 240 stores the program code of a boot loader for booting the multimedia device 200. The secondary components 250 are added according to an operation requirement and specific functions of the multimedia device 200. Taking a smart TV as an example of the multimedia device 200 in the present embodiment, the smart TV (i.e., the multimedia device 200) includes an audio decoder 260, a video decoder 270, a display unit 280, and/or a combination of foregoing devices to enhance audio, video, and display functions. However, those implementing the present embodiment should know that the multimedia device 200 is not limited to aforementioned smart TV. The implementation of the multimedia device 200 will not be described herein.

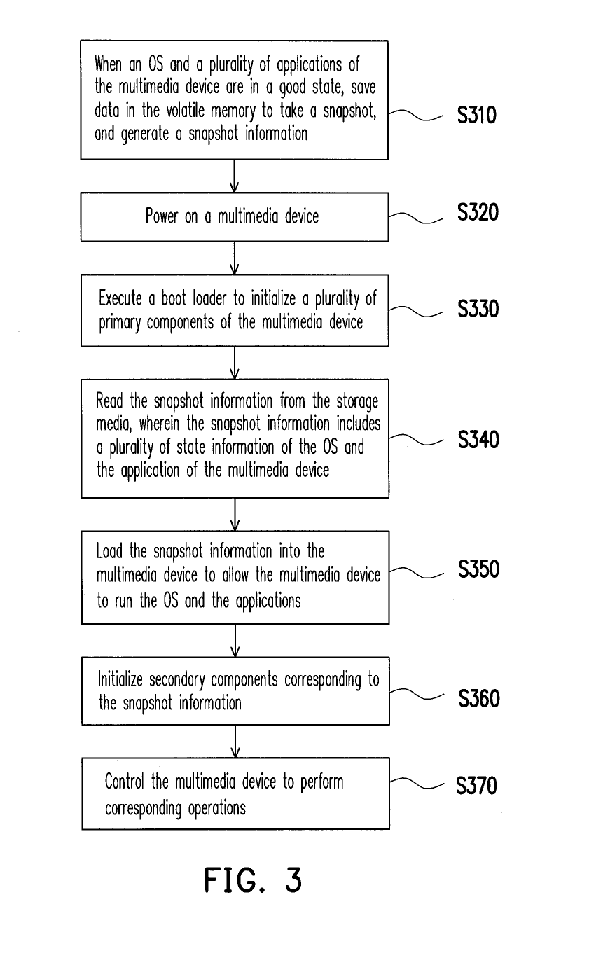

FIG. 3 is a flowchart of a booting method of the multimedia device 200 according to the first embodiment of the invention. Below, the booting method of the multimedia device 200 described in the first embodiment will be explained in detail with reference to the multimedia device 200 illustrated in FIG. 2 and FIG. 3. In the present embodiment, because a snapshot has to be taken regarding related state of the OS and the applications at a time point when the OS and the applications can all operate normally (i.e., the OS and the applications are all in a good state at this time point) to obtain a snapshot information, in step S310, after the multimedia device 200 is manufactured, the manufacturer powers on the multimedia device 200 normally with the same hardware equipment, saves data in the volatile memory 230 of the multimedia device 200 to generate the snapshot information at the time point when the OS and the applications of the multimedia device 200 are in a good state, and stores the snapshot information into the non-volatile storage media 220 of the multimedia device 200 (for example, a cache memory), so as to standardize smart TVs with the same hardware specifications. Namely, the snapshot information includes and keeps state information of the OS and the applications at the time point, and a user needs not to configure aforementioned snapshot information.

The “snapshot information” mentioned in the present embodiment carries various state information of software when the software works normally. For example, in the present embodiment, the program codes of all software (the OS and the applications) in the multimedia device 200 are adjusted to allow the software to operate by using finite-state machines (FSMs) and allow a snapshot to be taken on the software in the good state. In other words, in the present embodiment, when the OS and the applications are in the good state, a plurality of state information (for example, state flags and memory buffering areas, etc.) to be accessed by a plurality of FSMs is respectively saved and backed up to generate the snapshot information. The snapshot information contains the state information of each software. Thus, in the present embodiment, when a snapshot is taken, the operation state of each hardware module and each software can be correctly saved and corresponding processing can be carried out accordingly. In an application of the present embodiment, parallel software or threads on the multimedia device 200 are ran at a fixed time point by using a specific software, and a snapshot is taken on current information in the volatile memory 230 by using another software, so that the multimedia device can be resumed by using previous snapshot information when the multimedia device is booted again.

In step S320, after the user powers on the multimedia device 200, step S330 is executed, in which the central processing unit 210 reads a program code of a boot loader from the boot loading unit 240 and executes the boot loader to initialize a plurality of primary components of the multimedia device 200. However, the invention is not limited there to, and in some embodiments, step S330 may also be executed by a specially designed boot loading unit 240 instead of the central processing unit 210.

Aforementioned primary components refer to the central processing unit 210, the storage media 220, and the volatile memory 230 of the multimedia device 200. In the smart TV of the present embodiment, the boot loading unit 240 is implemented as a Basic Input/Output System (BIOS) 240, and the BIOS 240 is coupled to the central processing unit 210 through a south bridge unit in the chipset. Accordingly, when the central processing unit 210 is powered on, it executes the boot loader to initialize the storage media 220, the volatile memory 230, and other primary components.

After the boot loader is executed, in step S340, the central processing unit 210 reads the snapshot information stored in step S310 from the storage media 220. In step S350, the central processing unit 210 loads the snapshot information into the volatile memory 230 of the multimedia device 200 so that the multimedia device 200 can skip the initialization step and instantly run the OS and the applications.

Regarding aforementioned operation of “loading the snapshot information”, the central processing unit 210 respectively writes state information (for example, state flags and memory buffering areas, etc.) to be accessed by the FSMs when the OS and the applications are in the good state to corresponding memory addresses of the volatile memory 230 according to the snapshot information stored in step S310, so as to skip the initialization step and allow the OS and the applications to instantly enter the good state and start to operate.

Additionally, in steps 5340 and S350 of the present embodiment, only related states of software in the multimedia device 200 is instantly resumed by using the snapshot information, and the corresponding hardware components (for example, the secondary components 250) are not resumed. For example, after step S350, even though the multimedia device 200 already resumes the driver of the secondary components 250 (for example, the driver of an audio decoder 260), it does not initialize the hardware of the secondary components 250 according to the snapshot information and accordingly the audio decoder 260 cannot work. Thus, states of the hardware components need to be adjusted to match the snapshot information. In other words, corresponding hardware components to be adjusted during the initialization of the OS and the applications are initialized again to resume the hardware components to the time point corresponding to the good state.

Thus, in step S360, the multimedia device 200 still initializes the secondary components corresponding to the snapshot information. Then, in step S370, the user immediately controls the multimedia device 200 to perform corresponding operations. In the present embodiment, the multimedia device 200 can re-initialize the secondary components 250 by using an application programming interface (API) (i.e., set values in the secondary components 250) that need to be set initially.

In the present embodiment, all the software are resumed at the same time to the good state by using the snapshot information so that it is not needed to initialize each software of the multimedia device 200 one by one. Thus, the number of booting steps of the multimedia device 200 is reduced and the booting time of the multimedia device 200 is effectively shortened.

It should be mentioned that in step S310 of the present embodiment, the snapshot information is generated by saving all data in the volatile memory 230 when the OS and the applications of the multimedia device 200 are in the good state. However, in an actual application, the volatile memory 230 also temporarily stores data not used in the booting method (for example, data buffering areas, picture buffering areas, audio/video buffering areas, files, and databases that are frequently accessed and are not used for marking states) besides the states of the software. Contrarily, the data to be saved is the application buffering areas managed by the OS and the applications. The smaller a snapshot file is, the faster the loading step of the multimedia device 200 is completed. Thus, in the present embodiment, the file size of the snapshot information to be saved and backed up should be as small as possible.

In the present embodiment, a plurality of storage pages in the currently used volatile memory 230 is saved to take snapshots respectively on a plurality of states of the OS and the applications and respectively generate the state information in the snapshot information. Aforementioned storage pages in the volatile memory 230 refer to physical structure of data continuously stored in the volatile memory 230 when the OS manages the volatile memory 230. The OS cannot address data in the volatile memory 230 therefore cannot manage the data properly. Thus, the OS manages data in the volatile memory 230 in unit of 4 KB or 8 KB, wherein each unit of data is corresponding to a specific address.

Assuming that in the present embodiment, data in the volatile memory 230 is managed as storage pages in unit of 4 KB, the central processing unit 210 identifies read-only insignificant data in the volatile memory 230 according to information provided by the OS and not saves such data into the snapshot information, so as to reduce the file size of the snapshot information.

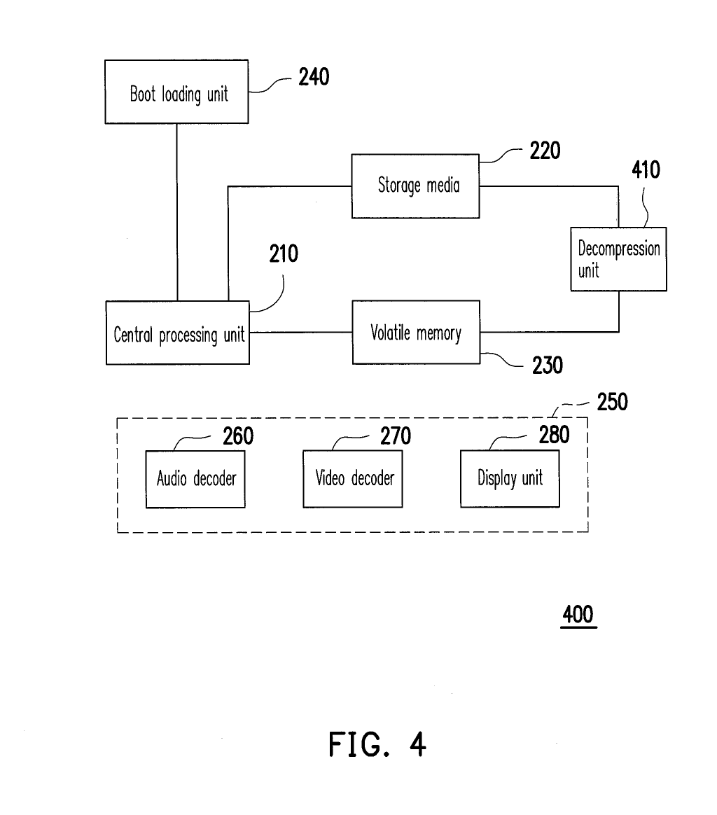

On the other hand, the file size of the snapshot information is further reduced by using a lossless compression/decompression algorithm in a second embodiment of the invention. FIG. 4 is a function block diagram of a multimedia device 400 according to the second embodiment of the invention. The booting method illustrated in FIG. 3 is also applicable to the multimedia device 400. The second embodiment is similar to the first embodiment therefore can be referred to foregoing description of the first embodiment. Referring to both FIG. 3 and FIG. 4, the difference between the second embodiment and the first embodiment is that the multimedia device 400 further includes a decompression unit 410, wherein the decompression unit 410 is coupled between the storage media 220 and the volatile memory 230 through the DMA technique. In step S310 of the present embodiment, the multimedia device 400 executes the lossless compression algorithm by using a software, so as to generate the snapshot information stored in the storage media 220. When the snapshot information is read in step S340, the snapshot information is decompressed by using the decompression unit 410 implemented as hardware, so as to restore the original snapshot information. Whether this implementation is faster than the first embodiment is determined according to whether the time spent by the lossless compression algorithm for reading and decompressing cache data is comparable to the time spent on reading uncompressed cache data. The lossless compression algorithm may be the GNU zip (GZIP) algorithm, the Lempel Ziv Oberhumer (LZO) algorithm, or any other exclusive data compression/decompression algorithm

In the present embodiment, the boot loading unit 240 and the decompression unit 410 can be integrated into a single booting-specific processing unit. Namely, a specially designed boot loading unit 240 can be adopted in the invention for directly loading the snapshot information in the storage media 220 into the volatile memory 230, so that the central processing unit 210 needs not to perform the loading operation. If the snapshot information is compressed, corresponding function of the decompression unit 410 needs to be integrated with the specially designed boot loading unit 240 to decompress the snapshot information.

As described above, in a multimedia device and a booting method thereof provided by an embodiment of the invention, a snapshot is taken in advance on an OS and applications of the multimedia device when the OS and the applications are in a good state, so as to generate a current snapshot information. During the booting procedure of the multimedia device, the snapshot information is loaded so that the OS shell and the applications need not to be configured one by one as in the conventional booting procedure. Thereby, the number of booting steps of the multimedia device is reduced, and the booting time of the multimedia device is effectively shortened.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A booting method of a multimedia device, wherein the multimedia device comprises a storage media, the booting method comprising:
after the multimedia device is powered on, executing a boot loader to initialize a plurality of primary components of the multimedia device;
reading a snapshot information from the storage media, wherein the snapshot information comprises a plurality of state information of an operating system (OS) and a plurality of applications of the multimedia device; and
loading the snapshot information into the multimedia device to allow the multimedia device to run the OS and the applications.

2. The booting method according to claim 1, wherein the multimedia device further comprises a volatile memory, and the booting method further comprises:
when the OS and the applications are in a good state, saving data in the volatile memory to take a snapshot, and generating the snapshot information.

3. The booting method according to claim 1, wherein the multimedia device further comprises a volatile memory, and the booting method further comprises:
when the OS and the applications are in a good state, saving a plurality of storage pages in the currently used volatile memory to respectively take snapshots on a plurality of states of the OS and the applications and respectively generate the state information in the snapshot information.

4. The booting method according to claim 1, wherein the snapshot information is compressed by using a lossless compression algorithm, and the booting method further comprises:
decompressing the snapshot information by using a decompression unit.

5. The booting method according to claim 1, wherein the multimedia device further comprises a volatile memory, and the step of loading the snapshot information into the multimedia device further comprises:
writing the state information while the OS and the applications are in a good state into the volatile memory according to the snapshot information.

6. The booting method according to claim 1, wherein the primary components comprise the storage media, a central processing unit, and a volatile memory.

7. The booting method according to claim 1, wherein after the step of reading the snapshot information, the booting method further comprises:
initializing a plurality of secondary components, wherein the secondary components are corresponding to the snapshot information.

8. The booting method according to claim 7, wherein the secondary components comprise one and/or a combination of an audio decoder and a video decoder.

9. A multimedia device, comprising:
a central processing unit;
a storage media, coupled to the central processing unit and configured to store a snapshot information, wherein the snapshot information comprises a plurality of state information of an OS and a plurality of applications of the multimedia device; and
a volatile memory, coupled to the central processing unit and the storage media, wherein
after the multimedia device is powered on, the central processing unit executes a boot loader to initialize a plurality of primary components of the multimedia device, reads the snapshot information from the storage media, and loads the snapshot information into the volatile memory to run the OS and the applications.

10. The multimedia device according to claim 9 further comprising:
a boot loading unit, storing a program code of the boot loader, wherein the central processing unit reads the program code of the boot loader from the boot loading unit to execute the boot loader.

11. The multimedia device according to claim 9, wherein when the OS and the applications are in a good state, the central processing unit saves data in the volatile memory to take a snapshot and generate the snapshot information.

12. The multimedia device according to claim 9, wherein when the OS and the applications are in a good state, the central processing unit saves a plurality of storage pages in the currently used volatile memory to respectively take snapshots on a plurality of states of the OS and the applications and respectively generate the state information in the snapshot information.

13. The multimedia device according to claim 9, wherein the snapshot information is compressed by using a lossless compression algorithm, and the multimedia device further comprises:
a decompression unit, coupled between the storage media and the volatile memory and configured to decompress the snapshot information.

14. The multimedia device according to claim 9, wherein the central processing unit writes the state information while the OS and the applications are in a good state into the volatile memory according to the snapshot information.

15. The multimedia device according to claim 9, wherein after reading the snapshot information, the central processing unit initializes a plurality of secondary components, wherein the secondary components are corresponding to the snapshot information.
